(19) United States
(12) Patent Application Publication
(10) Pub. No.: US 2011/0255929 A1
(43) Pub. Date: Oct. 20, 2011

(54) Universal Drill Stand

(76) Inventor: David J. Buchner, Janesville, WI (US)

(21) Appl. No.: 13/086,902

(22) Filed: Apr. 14, 2011

Related U.S. Application Data
(60) Provisional application No. 61/324,630, filed on Apr. 15, 2010.

(51) Int. Cl. B23B 45/14

(52) U.S. Cl. 408/137; 408/238

(57) ABSTRACT

A universal drill stand for supporting a hand-held drill in an elevated and inverted position for drilling holes or inserting fasteners into a concrete ceiling or other overhead surface. The universal drill stand is extendable for use with varying ceiling heights. It eliminates the need for a worker to construct scaffolding or ascend a ladder or other elevating device to drill each hole, allowing the worker to remain safely on the floor and away from dust and debris associated with the drilling.

### CROSS-REFERENCE TO RELATED APPLICATIONS

This application claims priority to U.S. Provisional Application No. 61/324,630 filed on Apr. 15, 2010.

### FIELD OF INVENTION

The present invention relates to the field of drilling of overhead surfaces and more particularly to universal drill stand for supporting a drill in an elevated position.

### BRIEF DESCRIPTION OF THE DRAWINGS

FIG. 1 illustrates an exploded view of an exemplary embodiment of a universal drill stand.

FIG. 2 illustrates a top view of an exemplary embodiment of tubular extensions nested.

FIG. 3 illustrates a perspective view of an exemplary embodiment of a universal drill stand in a deployed unextended position.

FIG. 4 illustrates a top view of an exemplary embodiment of a universal drill stand in a deployed unextended position.

FIG. 5 illustrates a side view of an exemplary embodiment of a universal drill stand in a deployed unextended position.

FIG. 6 illustrates a side view of an exemplary embodiment of a universal drill stand in a stowed position.

FIG. 7 illustrates a top view of an exemplary embodiment of a universal drill stand in a stowed position.

FIG. 8 illustrates a side view of an exemplary embodiment of a universal drill stand in a deployed extended position.

FIG. 9 illustrates a sectional view of an exemplary embodiment of a universal drill stand in a deployed extended position taken along line IX of FIG. 4.

FIG. 10 illustrates a sectional view of the tubular extensions nested.

### GLOSSARY

As used herein, the term “caster” refers to a wheel or any rotatable component that allows a structure to be moved without lifting.

As used herein, the term “friction-reducing surface component” refers to a component secured to a spline which allows the splined tubular components to move more freely in relation to one another. A friction-reducing surface component may include, but is not limited to strips, bearings, buttons, T-shaped components, and coatings.

As used herein, the term “selectively” means capable of being attached, detached, or repositioned.

As used herein, the term “spline” refers to a structural configuration which corresponds or mates with another component having a similar shape.

As used herein, the term “splined” means a component having at least one spline.

### BACKGROUND

Before installing fasteners into concrete ceilings for overhead surfaces, it is usually necessary to first drill holes. Holes are typically drilled using a hand-held power drill. This repetitive overhead drilling places a great deal of physical strain on a worker because not only must the worker support the weight of the drill, but apply upwardly drilling force as well.

To reach the overhead surface, the worker must typically construct scaffolding or ascend a ladder or other elevating device to drill each hole. For taller ceilings, a ladder may not reach or because of obstacles may not be able to be placed directly under the surface to be drilled or close enough to the drilling surface, requiring the worker to dangerously overextend to drill the hole. In addition, standing on a ladder or other elevating device positions the worker in close proximity to the dust and debris associated with the drilling of overhead concrete or other surfaces.

Stands for supporting a drill are known in the art. One example is disclosed in U.S. Pat. No. 6,095,724 (Hurt '724). For height adjustment, the stand taught by Hurt '724 uses a lever pivotally connected at a pivot point to a support collar, which is connected to the lower end of an outer column. An inner column is slidably located within the outer column. A linkage pivotally connects the lever to a locking compression collar and locking clamp. To adjust the height of the drill stand, the worker must unlock the locking clamp and then manually slide, in unison, the locking compression collar and locking clamp, the linkage, the support collar and outer column, and the lever upward or downward on the inner column, all while holding the inner column steady by positioning one of his or her feet on a foot plate. When the desired position is reached, the worker must manually lock the locking clamp.

The height adjustment and locking mechanism taught by Hurt '724 is not desirable because it is cumbersome to use. The worker must use both of his or her hands to move all the necessary components and at least one of his or her feet to steady the drill stand. When the selected height is reached, the worker must remove one of his or her hands from the adjustment and locking mechanism components to lock the locking clamp, while supporting all components with the remaining hand. In addition, drill stand taught by Hurt '724 must be picked up and carried from one drilling location to the next.

It is desirable to have a drill stand that is not cumbersome to adjust.

It is desirable to have a drill stand that does not require manual height adjustment.

It is desirable to have a drill stand that does not need to be steadied by the worker's foot when adjusted.

It is further desirable to have a drill stand which does not need to be carried between drilling locations.

### SUMMARY OF THE INVENTION

The present invention is a universal drill stand for drilling holes or inserting fasteners in concrete ceilings or other overhead surfaces. The universal drill stand is comprised of four tubular extensions; the first tubular extension has the largest diameter with each successive tubular extension having a slightly smaller diameter, allowing the tubular extensions to nest and move slidably inside one another. Each of the tubular extensions has a collar secured around the top end of the tubular extension. The second, third, and fourth tubular extensions may be raised, extending the height of universal drill stand for use with varying ceiling heights. A drill saddle secured to a top cover on the collar on the fourth tubular extension supports a hand-held drill. A tripod assembly and a drive motor and lead screw assembly are secured near the bottom of the universal drill stand.

### DETAILED DESCRIPTION OF INVENTION

For the purpose of promoting an understanding of the present invention, references are made in the text to exemplary embodiments of a universal drill stand, only some of which are described herein. It should be understood that no limitations on the scope of the invention are intended by describing these exemplary embodiments. One of ordinary skill in the art will readily appreciate that alternate but functionally equivalent components, dimensions, and materials may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

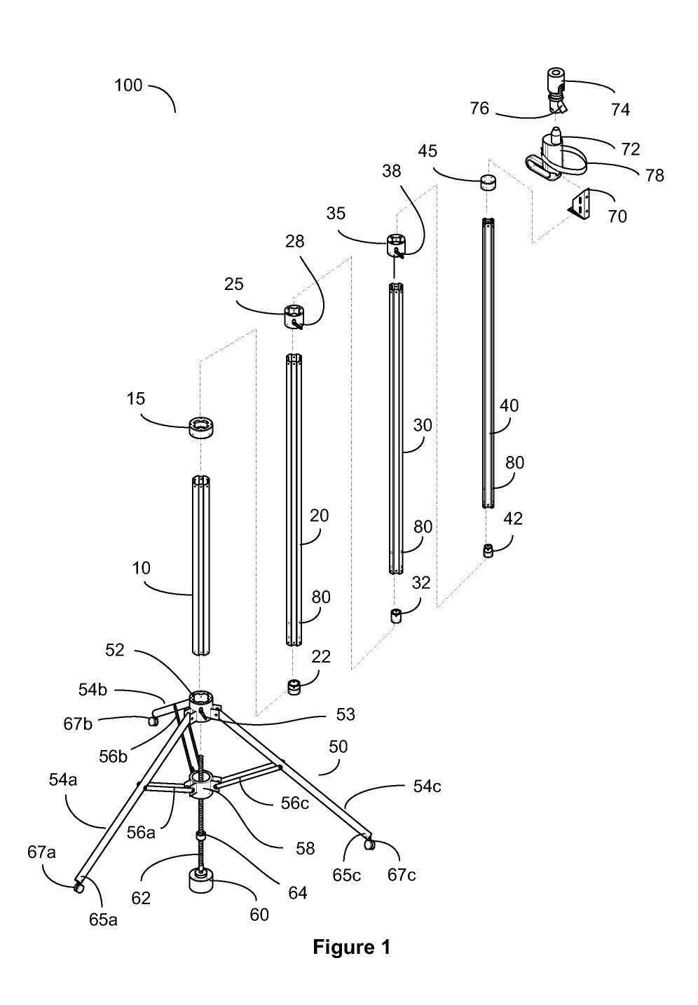

FIG. 1 illustrates an exploded view of an exemplary embodiment of universal drill stand 100. Universal drill stand 100 is comprised of four tubular extensions: first tubular extension 10, second tubular extension 20, third tubular extension 30, and fourth tubular extension 40. First tubular extension 10 has the largest diameter with each successive tubular extension having a slightly smaller diameter which allows tubular extensions 10, 20, 30, 40 to nest and move slidably inside each other.

In the embodiment shown, tubular extensions 10, 20, 30, 40 are approximately 0.625 inches thick, with first tubular extension 10 having a length of approximately 50 inches and second, third, and fourth tubular extensions 20, 30, 40 having a length of approximately 60 inches. In various embodiments, the thickness and lengths of the tubular extensions may vary. For example, the thickness of tubular extensions 10, 20, 30, 40 may range from 0.030 to 0.125 inches. In still other embodiments, the number of tubular extensions may vary. For example, universal drill stand 100 may be comprised of only two tubular extensions or may have 5 tubular extensions.

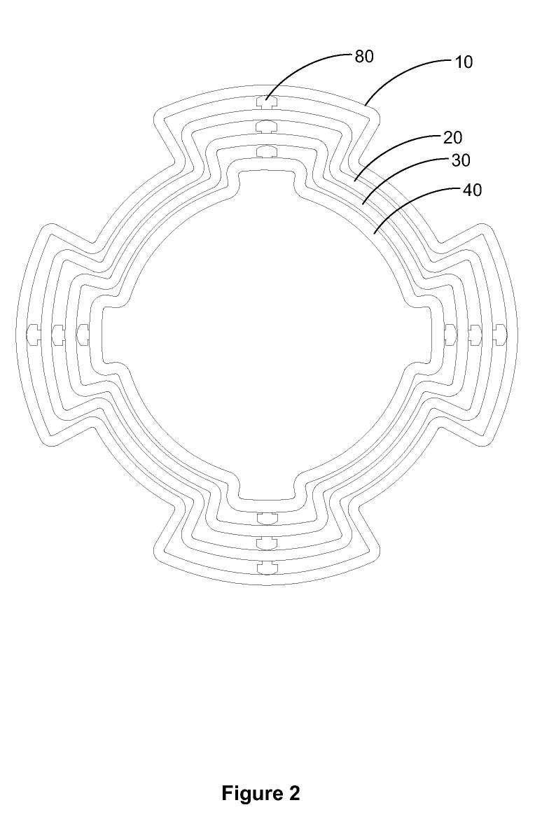

In the embodiment shown, first, second, third, and fourth tubular extensions 10, 20, 30, 40 are splined, each having four uniformly positioned splines which run the entire length of tubular extensions 10, 20, 30, 40. The splines of each successive tubular extension get smaller, allowing tubular extensions 10, 20, 30, 40 to nest inside one another (see FIG. 2). The inclusion of splines strengthens the tubular extensions and allows for linear movement, but restricts rotation of the tubular extensions within one another.

In an exemplary embodiment, one or more friction-reducing surface components 80 are secured to the external surface of each spline of tubular extensions 20, 30, 40. In the embodiment shown, friction-reducing surface components 80 are T-shaped components having a round, domed top. The ends of the T-shaped components are inserted into apertures in the center of the splines of the tubular extensions 20, 30, 40 until the round, domed top, which is larger than the aperture, is flat against the outer spline surface. The T-shaped components act as spacers between the tubular extensions, ensuring unrestricted linear movement of the tubular extensions and allowing any debris that gets into the tubular extension to drop through the tubular extension, preventing the debris from restricting sliding of the tubular extensions.

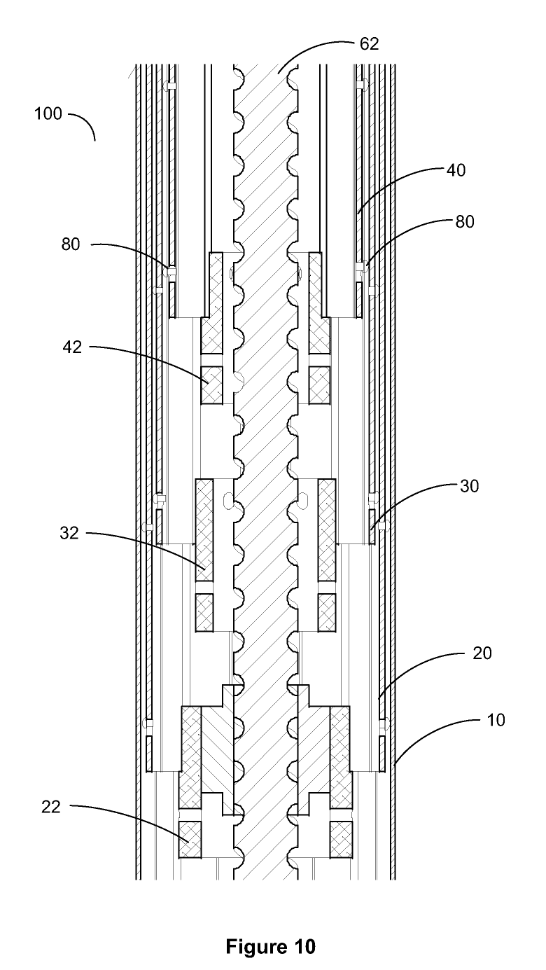

In an exemplary embodiment, two T-shaped components would be inserted into the center of each spline of tubular extensions 20, 30, 40; one approximately 0.5 inches from the bottom, the second approximately 7 inches from the bottom (see FIG. 10). In an exemplary embodiment, when tubular extensions 20, 30, 40 are fully extended, approximately 8 inches of overlap remains between successive tubular extensions. In various other embodiments, the number of inches of overlap when tubular extensions are fully extended may vary.

In an exemplary embodiment, friction-reducing surface components 80 are comprised of nylon; however, in other embodiments, may be comprised of another type of plastic or friction-reducing material. In various other embodiments, friction-reducing surface components 80 may have another shape (e.g., elongated strips) or may be a coating applied to the external surface of the splines.

Secured to the top of each tubular extension 10, 20, 30, 40 is tubular extension collar 15, 25, 35, 45, respectively. In an exemplary embodiment, tubular extension collars 15, 25, 35, 45 are secured by inserting fasteners through apertures in the collar and into apertures in tubular extensions 10, 20, 30, 40. Tubular extension collars 15, 25, 35, 45 maintain the spacing between the tubular extensions, allowing for free linear movement, as well as prevent tubular extensions from being completely separated one another.

Secured to the top of tubular extension collars 15, 25, 35 is a cover, approximately 0.125 inches thick, shaped to fit around the shape of tubular extensions 10, 20, 30, 40. Secured to the top of tubular extension collar 45 is a flat cover, approximately 0.25 inches thick, for securing drill saddle 70. The covers prevent dust and debris from getting inside the collars.

Each tubular extension collar 15, 25, 35, 45 has a diameter that is slightly larger than the diameter of the corresponding tubular extension 10, 20, 30, 40. In the embodiment shown, tubular extension collar 15 has a height of approximately 1 inch, an inner diameter of approximately 3.02 inches, and an outer diameter of approximately 4 inches. Tubular extension collars 25, 35 have a height of approximately 2.5 inches with an outer diameter of approximately 3.25 and 3 inches, respectively, with the bottom 1.5 inches having a larger inner diameter than the top 1 inch. The bottom of tubular extension collar 25 has an inner diameter of approximately 2.512 inches and the top has an inner diameter of approximately 2.77 inches. The bottom of tubular extension collar 35 has an inner diameter of approximately 2.238 inches and the top has an inner diameter of approximately 2.53 inches. Tubular extension collar 45 has a height of approximately 1.25 inches with an outer diameter of approximately 2.5 inches, with the bottom 0.25 inches having a larger inner diameter than the top 1 inch. The bottom of tubular extension collar 45 has an inner diameter of approximately 2 inches and the top has an inner diameter of approximately 2.238 inches.

In the embodiment shown, second tubular extension collar 25 has clamping lever 28 and third tubular extension collar 35 has clamping lever 38. Clamping levers 28, 38 are used to secure the tubular extensions when universal drill stand 100 is extended. Clamping lever 28 secures second tubular extension 20 to third tubular extension 30 while clamping lever 38 secures third tubular extension 30 to fourth tubular extension 40. In other embodiments, first tubular extension collar 15 may also include a clamping lever.

Second, third, and fourth tubular extensions 20, 30, 40 have tubular extension bottom caps 22, 32, 42, respectively. Bottom caps 22, 32, 42 are secured to the bottom of tubular extensions 20, 30, 40. In the embodiment shown, the top portion of bottom caps 22, 42 has a smaller diameter than the bottom portion, allowing bottom caps 22, 42 to be secured partially inside the bottom of second and fourth tubular extensions 20, 40 while the entire length of bottom cap 32 has the same diameter. Bottom caps 22, 32, 42 provide structural support and a foundation for securing the collar covers. In various other embodiments, bottom caps 22, 32, 42 may be omitted.

Located near the bottom of universal drill stand 100 is tripod assembly 50. Tripod assembly 50 is comprised of leg bracket 52, collapsible leg members 54a, 54b, 54c, brace member pairs 56a, 56b, 56c, and base bracket 58.

Collapsible leg members 54a, 54b, 54c are pivotally connected to leg bracket 52. Brace member pairs 56a, 56b, 56c are pivotally connected to collapsible leg members 54a, 54b, 54c at one end and to base bracket 58 at the other end. Base bracket 58 is fixedly secured to the bottom of first tubular extension 10. In the embodiment shown, collapsible leg members 54a, 54b, 54c are in the deployed position.

In the embodiment shown, collapsible leg members 54a, 54b, 54c are tubular components and brace member pairs 56a, 56b, 56c are comprised of two flattened pieces secured to opposite sides of collapsible leg members 54a, 54b, 54c.

When universal drill stand 100 is assembled, leg bracket 52 encircles first tubular extension 10 and is secured into place by moving leg bracket lever 53 into the locked position. Base bracket 58 is fixedly secured to the bottom of first tubular extension 10.

In the embodiment shown, the bottoms of collapsible leg members 54a, 54b, 54c include aperture pairs 65a, 65b, 65c (65b not visible) (apertures located on opposite sides of collapsible leg members) for rotatably securing casters 67a, 67b, 67c to the bottom of each collapsible leg member 54a, 54b, 54c. Casters 67a, 67b, 67c allow universal drill stand 100 to be more easily moved between the drilling of each hole. In an exemplary embodiment, casters 67a, 67b, 67c include a brake, which allows the casters to be locked when universal drill stand 100 is positioned on an incline.

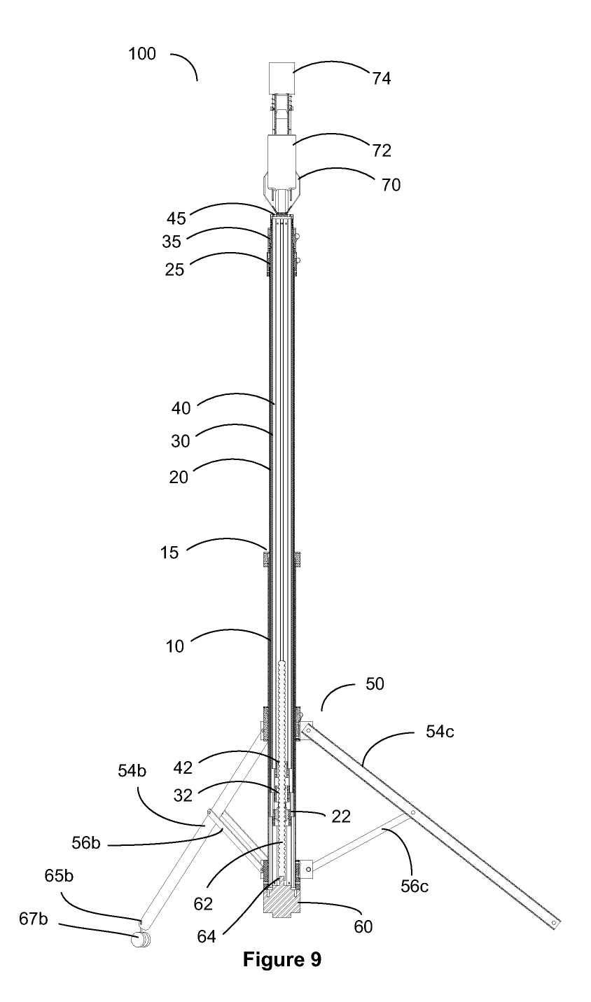

Also visible in the embodiment shown are drive motor and lead screw assembly 60, drill saddle 70, hand-held drill 72, and drill shroud 74. Drive motor and lead screw assembly 60 is secured below base bracket 58 so that lead screw 62 extends into tubular extensions 10, 20, 30, 40 when universal drill stand 100 is unextended (see FIG. 9). Also visible is lead screw nut 64. The drive motor rotates lead screw 62 which rotates lead screw nut 64 up or down, causing second tubular extension 20 to move up or down, driving the movement of third and fourth tubular extensions 30, 40 which are temporarily fixed to second tubular extension 20 (using collars 25, 35 and clamping levers 28, 38).

Drill saddle 70 is secured to the top cover of fourth tubular extension collar 45, by inserting fasteners through apertures in the bottom of drill saddle 70 into apertures in the top of collar 45. Hand-held drill 72 rests in drill saddle 70 with drill shroud 74 secured to the end of hand-held drill 70. In the embodiment shown, securing component 78 is used to further secure handle-held drill 72 to drill saddle 70. In the embodiment shown, securing component 76 is a strap with hook-and-loop fasteners which is secured around hand-held drill 72 and drill saddle 70.

In various other embodiments, drill saddle 70 may be secured to fourth tubular extension 40 through another means. For example, drill saddle 70 may be shaped to tightly conform to a specific model of hand-held drill or drill saddle 70 may further include an elongated tubular portion that extends from the bottom of drill saddle 70 and which is inserted directly into fourth tubular extension 40.

Drill shroud 74 fits over the top of hand-held drill 72 and catches dust and debris resulting from the drilling of the overhead surface. In various other embodiments, a bag may be secured to port 76 of drill shroud 74 to collect the debris and prevent it from falling into the components of universal drill stand 100 and on the user.

In the embodiment shown, tubular extensions 10, 20, 30, 40, collars 15, 25, 35, 45, leg bracket 52, collapsible leg members 54a, 54b, 54c, and base bracket 58 are comprised of extruded aluminum; however, in various other embodiments one or more components may be comprised of another type of metal, plastic, or other suitable material known in the art.

FIG. 2 illustrates a top view of first, second, third, and fourth tubular extensions 10, 20, 30, 40 nested showing the four uniformly positioned splines of each tubular extension. In various embodiments, tubular extensions 10, 20, 30, 40 may include fewer or more uniformly or non-uniformly positioned splines and/or splines of another shape which allow tubular extensions to nest and slide linearly within one another.

In the embodiment shown, first tubular extension 10 has a diameter of approximately 2.77 inches, second tubular extension 20 has a diameter of approximately 2.5 inches, third tubular extension 30 has a diameter of approximately 2.23 inches, and fourth tubular extension 40 has a diameter of approximately 1.9598 inches. In various embodiments, the diameters of tubular extensions 10, 20, 30, 40 may be smaller or larger (e.g., depending on the material used, the length of tubular extensions) and/or the ratio of diameters between successive tubular extensions may vary.

Also visible are friction-reducing surface components 80. In the embodiment shown, friction-reducing surface components 80 are T-shaped components having a round, domed top. The end of friction-reducing surface components 80 are inserted into apertures in tubular extensions 20, 30, 40 and are not visible.

In the embodiment shown, two T-shaped components are inserted into the center of each spline of tubular extensions 20, 30, 40; one approximately 0.5 inches from the bottom, the second approximately 7 inches from the bottom (see FIG. 10). In various other embodiments, fewer or more T-shaped components may be inserted into the splines of tubular extensions 20, 30, 40 and/or the placement of the T-shaped components may vary.

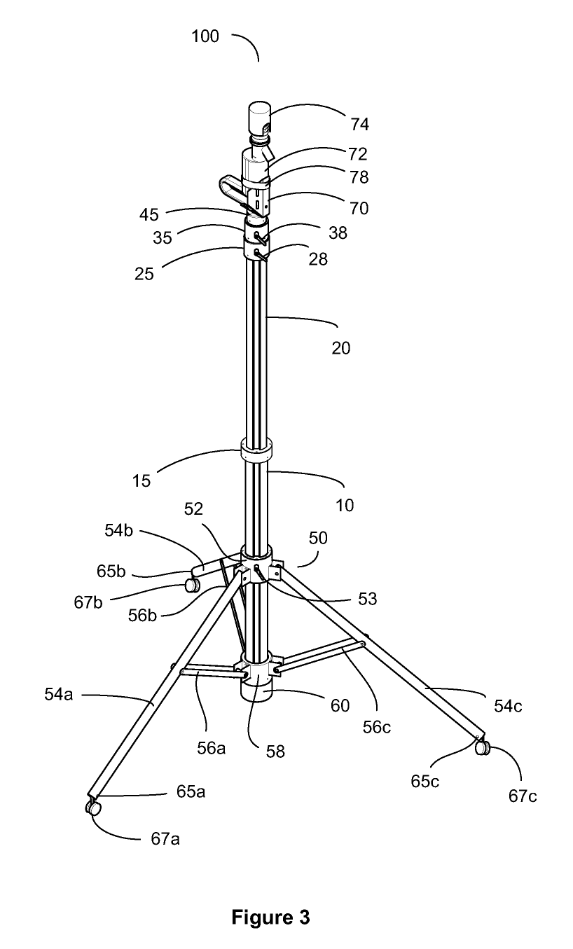

FIG. 3 illustrates a perspective view of an exemplary embodiment of universal drill stand 100 in a deployed unextended position. Only first and second tubular extensions 10, 20 are visible when universal drill stand 100 is in the unextended position; second, third, and fourth tubular extension collars 25, 35, 45 are stacked together under drill saddle 70.

When universal drill stand 100 is in a deployed position (unextended or extended), collapsible leg members 54a, 54b, 54c and brace member pairs 56a, 56b, 56c extend outward at an angle, and leg bracket 52 is positioned approximately half way between base bracket 58 and first tubular extension collar 15 with leg bracket lever 53 is the locked position.

In the embodiment shown, universal drill stand 100 is approximately 6 feet tall in the unextended position. In various other embodiments, universal drill stand 100 may be shorter or taller depending on the number of tubular extensions and/or the length of tubular extensions.

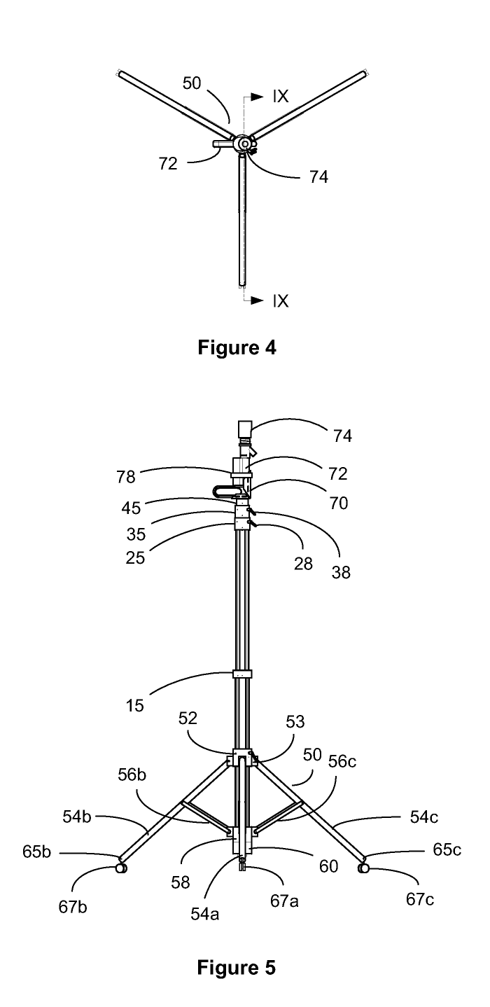

FIG. 4 illustrates a top view of an exemplary embodiment of universal drill stand 100 in a deployed unextended position showing the position of collapsible leg members 54a, 54b, 54c when universal drill stand 100 is in the deployed position.

FIG. 5 illustrates a side view of an exemplary embodiment of universal drill stand 100 in a deployed unextended position.

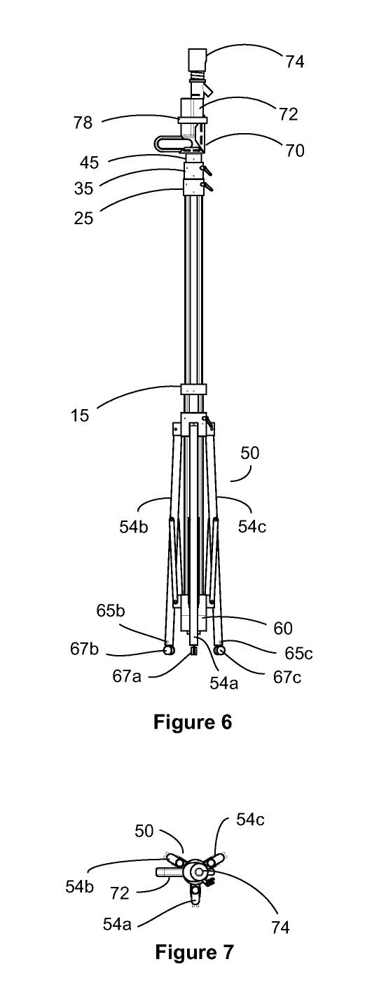

FIG. 6 illustrates a side view of an exemplary embodiment of universal drill stand 100 in a stowed position for maneuvering around obstacles, through tight spaces, and for transportation or storage. When universal drill stand 100 is in the stowed position, third and fourth tubular extensions 30, 40 are unextended and second and third tubular extension collars 25, 35 are stacked against fourth tubular extension collar 45.

To move universal drill stand 100 from a deployed position to a stowed position, leg bracket lever 53 is moved from a locked to an unlocked position and collapsible leg members 54a, 54b, 54c and brace member pairs 56a, 56b, 56c are folded inward. When collapsible leg members 54a, 54b, 54c are folded inward, leg bracket 52 slides upward on first tubular extension 10 and closer to first tubular extension collar 15. Leg bracket lever 53 is moved to the locked position to secure leg bracket 52 in position on first tubular extension 10.

FIG. 7 illustrates a top view of an exemplary embodiment of universal drill stand 100 in a stowed position showing the position of collapsible leg members 54a, 54b, 54c when universal drill stand 100 is in the stowed position.

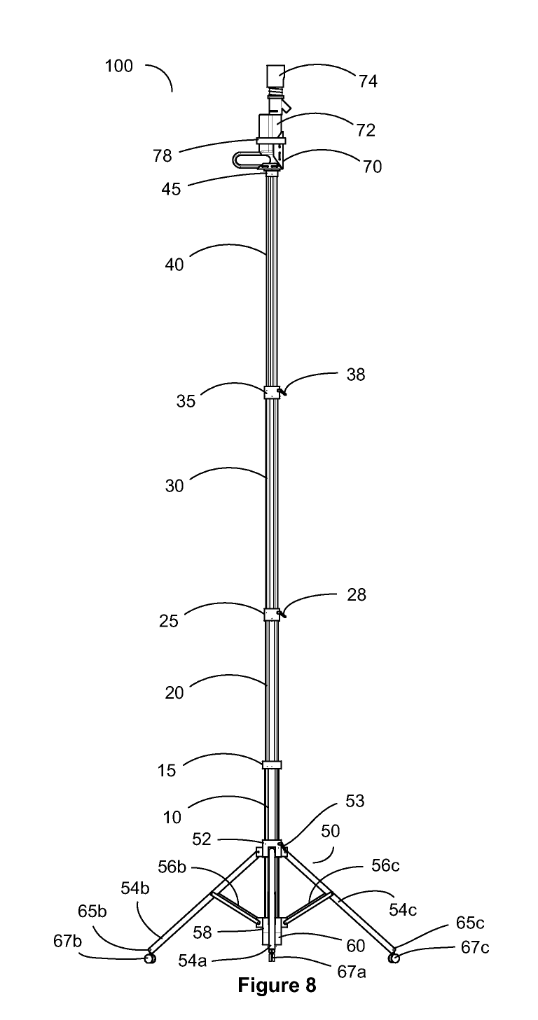

FIG. 8 illustrates a side view of an exemplary embodiment of universal drill stand 100 in a deployed extended position. To extend universal drill stand 100 to a fully extended position (as shown), third tubular collar lever 38 is moved from a locked to an unlocked position, allowing fourth tubular extension 40 to be removed from its position inside first, second, and third tubular extensions 10, 20, 30 and extended upward. When fourth tubular extension 40 is fully extended, collar lever 38 is moved to the locked position, securing fourth tubular extension 40 to third tubular extension 30. Next, second tubular collar lever 28 is moved from a locked to an unlocked position and third tubular extension 30 is removed from its position inside first and second tubular extensions 10, 20 and extended. When fully extended, collar lever 28 is moved to the locked position, securing third tubular extension 30 to second tubular extension 20. In various embodiments, the height that each of third and fourth tubular extensions 30, 40 are extended depends on the height of the ceiling.

When third and fourth tubular extensions 30, 40 are extended, drive motor and lead screw assembly 60 is used to extend second tubular extension 20. In the embodiment shown, second tubular extension 20 is capable of being raised approximately 3 feet. In various other embodiments, second tubular extension 20 is longer, allowing it to be extended greater than 3 feet.

Universal drill stand 100 is extended until the top of drill shroud 74 rests against the ceiling. In the embodiment shown, universal drill stand 100 is fully extended and has a maximum extended height of approximately 17 feet. In various embodiments, if the desired height is less than 17 feet, one or more of second, third, and fourth tubular extensions 20, 30, 40 may be partially or fully extended to achieve the desired height. In various other embodiments, universal drill stand 100 may have a maximum extended height less than or greater than 17 feet depending on the number and length of tubular extensions.

FIG. 9 illustrates a sectional view of an exemplary embodiment of universal drill stand 100 in a deployed unextended position taken along line IX of FIG. 4. When universal drill stand 100 is in a deployed unextended position, only first and second tubular extensions 10, 20 are exposed with third and fourth tubular extensions 30, 40 positioned inside first and second tubular extensions 10, 20. Second, third, and fourth tubular extension bottom caps 22, 32, 42 are positioned between base bracket 58 and leg bracket 52 when universal drill stand 100 is not extended.

Also visible in the embodiment shown, are lead screw 62 and lead screw nut. Lead screw 62 extends through bottom caps 22, 32, 42 and into tubular extensions 20, 30, 40.

A controller (e.g., similar to a joystick with up, down and speed controls) is used to control drive motor and lead screw assembly 60 to actuate second tubular extension 20 up and down and to apply pressure to drill shroud 74 (which activates hand-held drill 72) for drilling holes. In various other embodiments, hand-held drill 72 may be actuated using a separate controller (e.g., in the absence of the drill shroud).

In the embodiment shown, hand-held drill 72 is a drill used to drill holes in concrete ceilings or other overhead surfaces. In various other embodiments, hand-held drill 72 may be used to insert a screw, anchor, or another type of fastener into a concrete ceiling or other overhead surface (e.g., into pre-drilled holes).

FIG. 10 illustrates a sectional view of a portion of tubular extensions 10, 20, 30, 40 nested. Also visible are lead screw 62, bottom caps 22, 32, 42, and friction-reducing surface components 80.

In the embodiment shown, each spline of tubular extensions 20, 30, 40 has two T-shaped friction-reducing surface components 80; one approximately 0.5 inches from the bottom of tubular extensions 20, 30, 40, the second approximately 7 inches from the bottom of tubular extensions 20, 30, 40. In various other embodiments, fewer or more T-shaped components may be inserted into the splines of tubular extensions 20, 30, 40 and/or the placement of the T-shaped components may vary.

Universal drill stand 100 eliminates the need for a worker to construct scaffolding or ascend a ladder or other elevating device to drill each hole, allowing the worker to safely remain on the floor and away from dust and debris associated with the drilling. In addition, collapsible leg members 54a, 54b, 54c allow universal drill stand 100 to be maneuvered around obstacles and through tight spaces.

What is claimed is:

1. A universal drill stand apparatus comprised of:
at least one telescoping pole assembly comprised of at least one outer splined tube, said outer splined tube having at least one spline;
wherein said outer splined tube encloses at least one inner splined tube having at least one spline, said spline of said inner splined tube mates with said spline of said outer splined tube,
at least one splined tube locking assembly to selectively secure and release said inner splined tube from said outer splined tube;
a base component comprised of a leg bracket and at least three triangulated pivotal leg members, each of said triangulated pivotal leg members having a top end and a bottom end, each of said pivotal leg members further includes a caster rotatably attached to said bottom end, said leg bracket encircles said outer splined tube;
at least one drill support assembly comprised of an L-shaped drill platform, said L-shaped platform having at least one horizontal drill rest component and at least one vertical drill support component; and
at least one securing component which secures a hand-held drill to said L-shaped platform.

2. The apparatus of claim 1 wherein said securing component is a strap which encircles said L-shaped drill platform and a hand-held drill.

3. The apparatus of claim 1 which further includes a drive motor assembly.

4. The apparatus of claim 3 wherein said drive motor assembly further includes a lead screw and a lead screw nut, said lead screw rotates said lead screw nut to move said inner splined tube.

5. The apparatus of claim 1 wherein said splined tube locking assembly is comprised of a collar, a clamping component, and a lever.

6. The apparatus of claim 5 wherein said splined tube locking assembly further includes a sealing cover.

7. The apparatus of claim 1 which further includes a collar secured to the top of said outer splined tube.

8. The apparatus of claim 1 wherein said leg bracket further includes a clamping component and a lever.

9. The apparatus of claim 1 wherein said base component further includes radially positioned braces members secured at one end to one of said triangulated pivotal leg members, the second end of said brace members being secured to a base bracket, said radially positioned brace members pivot relative to said outer splined tube.

10. The apparatus of claim 9 wherein said base bracket is fixedly attached to said outer splined tube.

11. The apparatus of claim 1 wherein said inner splined tube further includes at least one friction-reducing surface component.

12. The apparatus of claim 11 wherein said friction-reducing surface component is comprised of nylon.

13. The apparatus of claim 12 wherein said at least one friction-reducing surface component is secured to the external surface of said at least one spline of said inner splined tube.

14. The apparatus of claim 12 wherein said friction-reducing surface component is a T-shaped spacer.

15. The apparatus of claim 14 wherein one T-shaped spacer has a round domed surface.

16. The apparatus of claim 1 wherein the ratio of diameters of said inner splined tube to said outer splined tube ranges from 1 to 1.108 to 1 to 1.138.

17. The apparatus of claim 1 wherein said outer splined tube and said inner splined tube have a thickness ranging from 0.030 inches to 0.125 inches.

18. The apparatus of claim 1 wherein said outer splined tube and said inner splined tube are comprised of extruded aluminum.

19. The apparatus of claim 1 wherein said telescoping pole assembly further includes at least one additional splined tube which is manually extended and retracted.
